(19) United States
(12) Patent Application Publication
(10) Pub. No.: US 2010/0052199 A1
(43) Pub. Date: Mar. 4, 2010

(54) Method for the operation of a production plant to produce an extrudate

(75) Inventors: Harald Sikora, Bremen (DE); Siegmar Lampe, Bremen (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Sikora AG, Bremen (DE)

(21) Appl. No.: 12/517,519

(22) PCT Filed: Nov. 7, 2007
(86) PCT No.: PCT/EP07/09623

§ 371 Date: Nov. 2, 2009

(30) Foreign Application Priority Data
Dec. 4, 2006 (DE) 10 2006 058 754.5

(51) Int. Cl. B29C 47/92

(52) U.S. Cl. 264/40.7

(57) ABSTRACT

A method for the operation of a production plant to produce an extrudate, in which at least one layer of the extrudate is extruded from plastic material in at least one extruder which is variable in the rotational speed of its screw, wherein the speed of the extrudate (line speed) is variable and in which further the diameter and/or or the wall thickness of the layer is measured by a measuring head in a distance from the extruder

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

Cables are usually made in the form that their conductor (core) is drawn through an extruder, which applies at least one insulation layer onto the conductor which consists of a suitable plastic material. After the extrusion, the cable or the extrudate is guided through a cooling path or a vulcanisation- or dry crosslinking path. The sheathing must have a minimum wall thickness, for reasons of insulation safety for instance. On the other hand, it is avoided to make the wall thickness too large without necessity, for reasons of materials saving or weight. It is therefore necessary to monitor the wall thickness or the diameter of a cable or extrudate permanently, and to provide measures which perform a correction when the preset values are exceeded or fallen below.

In plants for the manufacture of cables, it is known to arrange a measuring device for the external diameter in a small distance after the extruder in the production direction. This arrangement has the advantage that it yields measurement values for the operator instantly when the extrusion plant is set up, and that it permits a rapid regulation. However; it is a disadvantage that the arrangement of a measuring device between the extruder and the crosslinking- or cooling path, respectively, is undesired just on that location for different reasons. It is therefore also known to arrange a diameter measuring apparatus behind the cooling path. This has the disadvantage that only a very slow regulation is achieved. From EP 0 400 310 A2, it is known to arrange a first diameter measuring apparatus between extruder and cooling path, and a second diameter measuring apparatus behind the cooling path. Via a delay line memory, the measurement value of the first diameter measuring apparatus is input into a comparator device, into which the measurement value of the second diameter measuring apparatus is input also. The difference is input into a second comparator device, which is fed by the first measurement value and by a desired diameter value as well. The difference goes as system deviation to a control unit for the plant. The same regulates the rotational speed of the extrudes; for instance.

It is also known to measure the wall thickness of the sheathing of a cable. When a sheathing is mentioned in the following, a single-layer sheathing is to be understood for the sake of simplicity. Of course, the insulation of a cable can also consist of plural layers, which are formed by coextrusion or by means of several extruders arranged one after the other. Besides, it is also known to apply semiconductor layers on the conductor or on the outer insulation layer.

An X-ray measuring device is suitable for measuring the wall thickness, by way of which it is possible to determine the thickness of the individual layers of a sheathing and the diameter of the core. However, it is also possible to determine the thickness of a layer of a sheathing by measuring the diameter only, provided that at the same time, the diameter of the core can be assumed to be known or is measured before the extruder in the line direction. In order to take into account fluctuations of the diameter of the conductor (the core diameter), it is further known to compare the measured diameter values of the conductor via a delay line memory with the measurement value of the external diameter, so that the difference of external diameter and core diameter can be associated to the same location on the cable,

At given core diameter; the wall thickness of the sheathing depends on the output capacity of an extruder and on the so-called line speed. The output capacity depends primarily on the rotational speed of the extruder (the rotational speed of the screw). The line speed is preset by the drives which haul the conductor from a drum and draw the cable through the extruder and the cooling path to a take-up reel. Thus, the wall thickness results from the following formula:

$${W}_{V} = \frac{1}{2} \cdot ( \sqrt{{D}_{Core}^{2} + \frac{4}{π} \cdot \frac{{\dot{P}}_{ex} ( {n}_{ex} )}{{v}_{L} \cdot ρ}} - {D}_{Core} )$$

In this formula is Wv=wall thickness,
\dot{P}ₑₓ=output capacity of the extruder
nₑₓ=rotational speed of the extruder
vL=line speed
D_{Core}=diameter of the conductor (core)
ρ=specific gravity

$${\dot{V}}_{ex} = \frac{{\dot{P}}_{ex} ( {n}_{ex} )}{ρ} = volume output capacity of the extruder$$

As already mentioned, it is known to provide a wall thickness adjustment by measuring the real value for the wall thickness after the cooling path, with an X-ray device for instance, and comparing the real value with a preset desired value for the wall thickness. A PI controller outputs a corresponding correcting variable to the extruder, for changing the rotational speed of the screw thereof, for instance. Through this, its output volume is changed also, and consequently the wall thickness of the sheathing. As cooling paths can have a great length, hundred meters and more for instance, such a regulation is slow, of course, in particular when cables with large diameter of the sheathing are produced, which are extruded with line speeds of 10 to 100 m per minute for instance, at maximum output capacity of the extruder. The regulation could be made faster if a wall thickness measuring device could be arranged immediately behind the extruder. This is undesired for different reasons.

Pipes or tubes from plastic material are also manufactured with an extruder. Even in production plants for such extrudate material, measuring devices can often not be positioned immediately following the extruder, which would be desirable per se for reasons of measurement technique.

The present invention is based on the objective to indicate a method for the operation of a production plant to produce an extrudate, for cables in particular, by which the external diameter and/or the wall thickness of at least one layer of the extrudate or of the sheathing of the cable, respectively, can be brought to the desired rated value faster than conventionally, even though a measurement of the diameter or of the wall thickness immediately behind the extruder is omitted.

### BRIEF SUMMARY OF THE INVENTION

In the method of the present invention, a model of the extruder is memorised in a computer. Each extruder is characterised through the dependence of its output volume capacity (output volume per unit time) on the rotational speed of its screw. The ratio of rotational speed to output volume capacity is not persistently linear, but can be mapped by a function. If for instance a conductor with a preset diameter is coated in an extruder with a preset rotational speed and line speed, there results a predictable wall thickness. The described variables, like wall thickness and/or diameter; the extruder's rotational speed, the line speed, the internal diameter and/or the core diameter are measured and mapped in an algorithm, which is deposited in the software of the computer.

The volume output capacity of an extruder is further depending on the material, the temperature of the material (the mass temperature) and on the power of the drive of the extruder. The temperature and/or the drive power can be measured of course, the latter via the current acceptance of the drive motor, for instance.

In the manufacture of an extrudate, of a cable for instance, the line operator knows which wall thickness value is to be achieved for the layer wall or for the sheathing of the cable, respectively. At given core diameter, the wall thickness value to be achieved results from the preset speeds for the line and the rotational number of the extruder screw and from the further, parameters mentioned above. When there is no core, the internal diameter of the layer can be preset otherwise. When the line speed is increased about a certain percentage in the run-up of the production plant, the line operator must increase the rotational speed of the extruder correspondingly, in order to achieve the desired wall thickness. Due to the nonlinearity of the extruder, the rotational speed of the extruder must be increased about a certain greater percentage in order to maintain the desired wall thickness. With the aid of the extruder model, the wall thickness value achieved at each time can be calculated and displayed instantly, even during the operation in the starting period. This wall thickness value results form the algorithm expressed in the extruder model, by means of which the respective wall thickness is calculated depending on the production data of the extruder, the line speed and external and core diameter, respectively, said wall thickness changing above all with the rotational speed value of the extruder, as is well known. As a result, with the aid of the extruder model, the wall thickness value can be advanced by the line operator in a time as fast as possible to that value which is preset as a rated value for him/her. This takes place either by manual actuation for the adjustment of the rotational speed (the screw's rotational speed) of the extruder, or even alternatively with the aid of a suitable control and regulation, which provides that the extruder is triggered and controlled such that the calculated value corresponds to the rated value, or the rated value is achieved after a regulation process, respectively.

According to the present invention, it can be switched over to automatic operation still before running tip the plant to production speed. For the automatic operation, it is provided according to the present invention to memorise the algorithm of an (inverse) extruder model in the computer, from which the relation of the extruder's rotational speed to the value for the diameter and/or the wall thickness emerges in accordance with the inside or core diameter, respectively, the line speed and the rotational speed dependent output capacity of the extruder. The extruder is controlled with a desired rotational speed, which is calculated in the (inverse) extruder model for the preset values of wall thickness and/or diameter, line speed and inside or core diameter, respectively. When beginning the automatic operation, the extruder is controlled with the calculated desired rotational speed, so that a wall thickness is thus generated which corresponds to the rated wall thickness to a large extent, due to the calculation in the extruder model, without that a measurement had been performed for this. The latter can take place only when the output with the predicted wall thickness has reached the measuring head in a greater distance to the extruder. The measuring head measures the real value for the diameter and/or the wall thickness of the layer or sheathing, respectively. Due to the approach to a large extent of the wall thickness that was calculated with the aid of the extruder model to the rated wall thickness or the rated diameter, respectively, the difference between real and desired value is relatively small. The deviation or difference is used for adjusting the extruder more accurately to the desired value for diameter or wall thickness. This may take place optionally by a regulation or by adaptation (correction) of the extruder model in accordance to the measurement values from the measuring head. For instance, the measured wall thickness is compared with a predicted wall thickness in a regulation, wherein it is essential that the wall thickness value, predictable or calculated in advance, is compared with the measurement value of the measuring head on the location of the measuring head. For instance, this takes place in that the wall thickness value calculated in the extruder model is given up via a shift register to a comparators device, into which the measured wall thickness value is input also. In the “location-adjusted” comparison, further process relevant data like the rotational speed of the extruder's screw, hauling speed etc. have to be taken into account as far as possible. Namely, the same might have changed more or less significantly in the course of the time in which the extrudate or the cable, respectively, has covered the path between extruder and measuring head. They are therefore continuously supplied to a memory which is similar to a delay line memory. The delay time of the information corresponds to the line speed, so that the same arrives on the location of the measuring head in a time-adjusted manner with the extrudate or the cable, respectively. By doing so, the real value of the wall thickness or of the diameter can be compared with the previously calculated values and the basic data on which the calculated values are based in a location-adjusted manner, in order to derive an error signal. The error signal causes a correction of the extruder model and/or of the desired value presettings for the extruder's rotational speed and/or for the line speed.

In the method of the present invention, it is assumed that the extruder model represents a relatively accurate approximation of the real production values (output capacity) of the specific extruder which is used. In the method of the present invention, the rotational speed of the extruder, which is desired to yield the desired wall thickness values at known output capacity, given internal or core diameter, respectively, and given line speed as well as at further given basic data mentioned above, is therefore obtained through a mathematical approximation at first. Examination and correction take place with the aid of actual measurement values, which are obtained by way of the measuring head in a distance to the extruder, for instance at the end of the cooling path. The method of the present invention has the advantage that in the beginning of the production, by presetting the extruder's rotational speed from the extruder model, the wall thickness can be controlled to a value which is only affected with a minimal error. A fine adjustment takes place thereafter, with the aid of the measurement values of the measuring head. In other words, the method of the present invention works as if a measuring head (a virtual measuring head) were arranged between extruder and cooling path, which indicates the cold wall thickness directly, which is not the case in reality. The virtual measuring head presets the desired rotational speed for the wall thickness and/or diameter control for each line speed. The measuring head behind the cooling path determines the real value through which the desired rotational speed of the extruder model is adjusted. For instance, this takes place by adaptation of the extruder model, or by way of regulation technique through a comparison of the measured real value of the wall thickness with the desired value for the wall thickness. The regulation portion in the adjustment of the extrudes according to the present invention is small. The delay time of the regulation path is therefore not particularly significant.

It is obvious that for the implementation of the extruder model, the parameters of the extruder, in particular its rotational speed, the line speed of the extrudate as well as the inside diameter or the thickness of the core, respectively, and if need be the material, its temperature and the mass pressure in the extruder must be known, and have to be measured by suitable measuring apparatuses if needed.

It is also obvious that the implementation of the extruder model functions also when the desired value of the line speed is predicted instead of the desired value for the extruder screw's rotational speed, and is correspondingly adapted, corrected or regulated when there is a deviation from the desired value of the wall thickness and/or of the diameter, respectively.

For instance, when the rotational speed of the extruder is significantly decreased or increased in the operation, for instance because the supply roll for the conductor in the cable manufacture must be changed, it has naturally to be taken care that the wall thickness and/or the diameter of the cable does not change in this. A rapid decrease of the rotational speed of the extruder does not result in an analogously rapid reduction of the output volume per unit time. Therefore, there is the danger of a so-called excessive wall thickness. To the reverse, an extruder cannot immediately “respond” to the sudden increase of its rotational speed with a corresponding output capacity, through which an insufficient wall thickness results. In the state of the art, one manages this for instance in that the extruder's rotational speed as well as the line speed are changed as slowly that the dynamic behaviour of the extruder does no more play any role. However, in this it must be considered that due to the nonlinearity of the extruder at different line speeds, the ratio of line speed and extruder's rotational speed must be changed correspondingly, in order to maintain a desired wall thickness in the static operation.

One embodiment of the present invention provides to detect and to model the dynamic behavior, i.e. the behaviour of the extruder output capacity at a rapid change of the screw's rotational speed. The output capacity behaves similar to a low-pass of the n-th order when the rotational speed changes. The parameters of such a low-pass model can be determined by way of the response of the extruder to a rapid change of the rotational speed (a jump function). Then, this model can serve to impart the same dynamic behaviour to the line speed by way of a control, in order to compensate the delayed behaviour of the extruder in the dynamic operation such that the wall thickness or the diameter remains essentially constant. Through this, the danger of an excessive or insufficient wall thickness is eliminated.

Thus, with the aid of the method of the present invention, the dynamic behaviour of an extruder can be introduced in a simple manner into the control and regulation of the wall thickness or of the diameter, respectively.

### BRIEF DESCRIPTION OF THE SEVERAL VIEWS OF THE DRAWINGS

The present invention is explained in more detail in the following by means of an example of its realisation, depicted in drawings.

FIG. 1 shows a plant for manufacturing a cable, in a schematic fashion;

FIG. 2 shows a block diagram of an arrangement for executing the method according to the present invention;

FIG. 2a shows a block diagram similar to that of FIG. 2, wherein the desired value for the line speed is predicted;

FIG. 3 shows a block diagram of a control and a regulation for the arrangement of FIG. 2;

FIG. 4 shows the block diagram of FIG. 3 for a manual operation; and

FIG. 5 shows the block diagram of FIG. 3 for an automatic operation.

### DETAILED DESCRIPTION OF THE INVENTION

While this invention may be embodied in many different forms, there are described in detail herein a specific preferred embodiment of the invention. This description is an exemplification or the principles of the invention and is not intended to limit the invention to the particular embodiment illustrated.

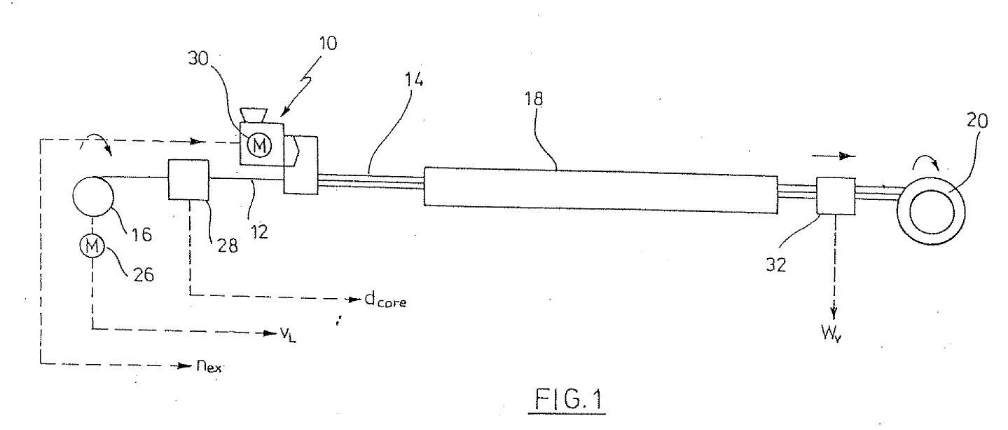

In FIG. 1, an extruder 10 is shown, with the aid of which a plastics sheathing is performed onto a conductor 12 in order to produce a cable 14. The conductor 12 (the core) is unwound from a not shown feed drum with the aid of a hauling device 16. The cable 14 is guided through a cooling path 18, and leaves the same in a cooled condition and is wound up on a drum 20. For this purpose, the drum 20 is driven by a motor. The hauling device 16 determines the production- or line speed, which is variable, however. Thus, a measuring head 26 is assigned to the core 12, which measures the line speed. Between hauling device 16 and extruder 10 is arranged a further measuring head 28, which measures the diameter of the conductor or core 12, respectively. The diameter is designated with Dcore. To the extruder 10 is assigned a measuring head 30, which measures the rotational speed nex of the extruder 10. Behind the cooling path 18 is arranged a measuring head 32, which measures the wall thickness Wv of the sheathing, which is applied to the conductor 12 by the extruder 10. A suitable, per se known X-ray measuring device can be used for this purpose. In order to measure the wall thickness, a diameter measuring device can be used also, for instance, because the measuring head 28 measures the diameter of the conductor 12, and the wall thickness results from the difference between the diameter of the cable and the diameter of the core, as is well known.

The volume output per unit time (the output capacity) of the extruder 10 depends of course on its screw's rotational speed, amongst others. The wall thickness of the sheathing of the cable 14 further depends on the speed by which the core 12 is guided through the extruder 10, as well as on the diameter of the core 12. At given line speed VL and preset core diameter, the wall thickness can therefore be changed by changing the rotational speed nex of the extruder's 10 screw.

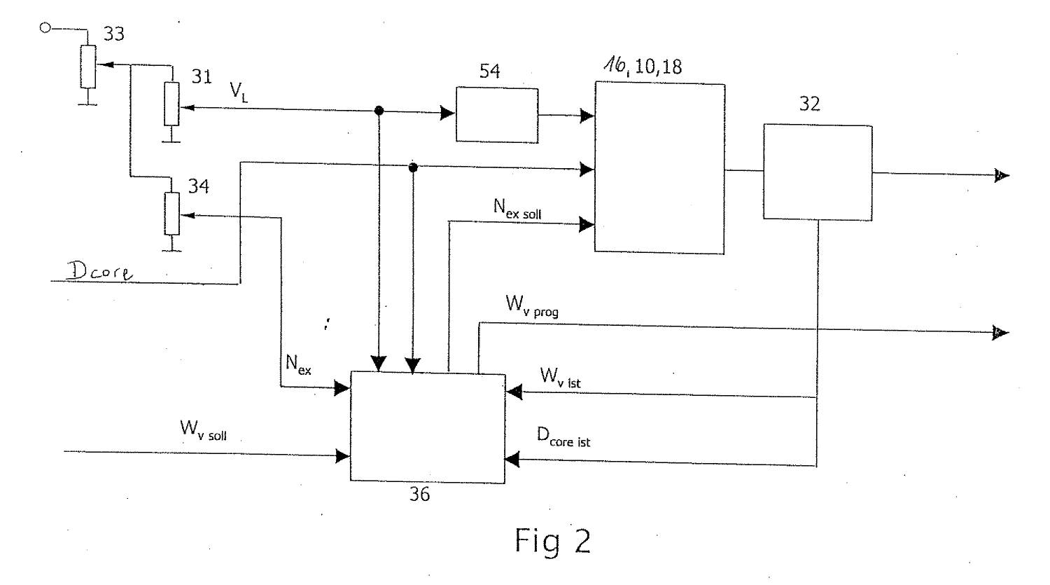

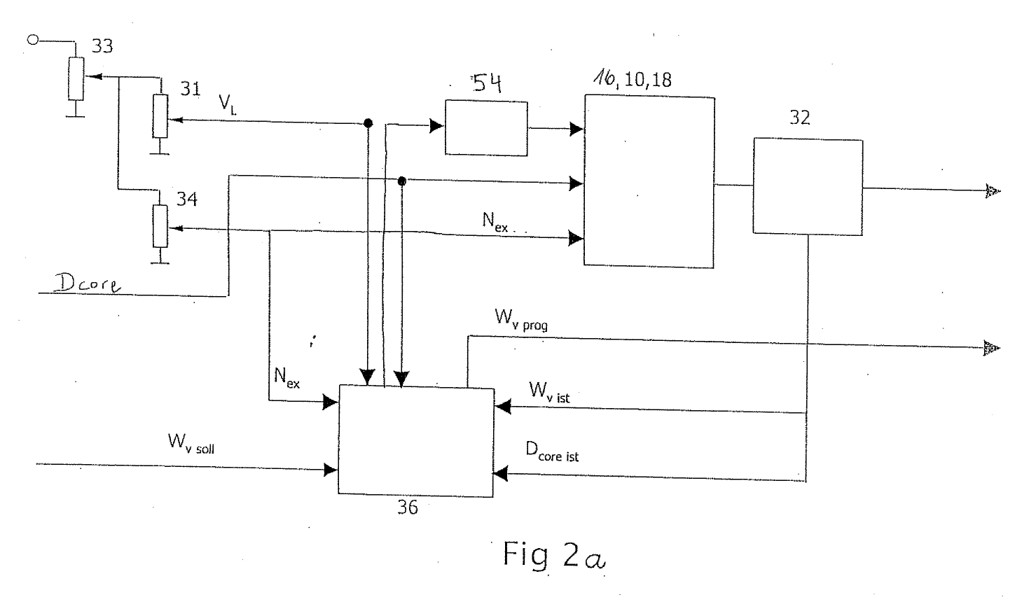

In the arrangement after FIG. 2, the drive of the cable 16, the extruder 10 and the cooling path 18 after FIG. 1 are indicated together in the block. The same includes also the drives for hauling off the cable, which are not shown in FIG. 1. A first desired value transmitter 31 in the form of a potentiometer presets the line speed vL. A second desired value transmitter 34 in the form of a potentiometer presets the rotational speed (screw rotational speed) for the extruder. The two desired value transmitters 31, 34 are adapted to be changed by way of a so-called “master potentiometer” 33 such that their ratio remains constant. The rotational speed nex and the desired wall thickness for the sheathing of the cable Wvsoll is given tip to a “virtual measuring head” 36, which receives also the measurement value for the core diameter Dcore, as well as the value for the line speed VL. As will still be explained in the following, the virtual measuring head 36 contains a model of the extruder 10, and if need be a wall thickness regulation. The latter will also be explained in more detail below. By calculation, the virtual measuring head 36 generates a desired value of the rotational speed for the extruder 10 nexsoll as an adjustment value for the extruder 10, alternatively after FIG. 2a, the vitual measuring head 36 generates by calculation a desired value vexsoll as adjustment value for the line speed via the drive 16. Besides, the virtual measuring head 16 generates a display value for the wall thickness of the sheathing, which is predicted on the basis of the data present in and input into the virtual measuring head. The same is designated by Wvprog in FIG. 2. The line operator can read this value on his/her display table. It is relatively near to the definitive desired value for the wall thickness Wvsoll. However, the measuring head 32 measures the really generated wall thickness and gives it up to the virtual measuring head 36. The difference between measured and predicted wall thickness (Wvsoll−Wvist) is used for regulating the extruder 10 or the line speed via the drive 16, or to adapt the extruder model in the virtual measuring head 36 correspondingly.

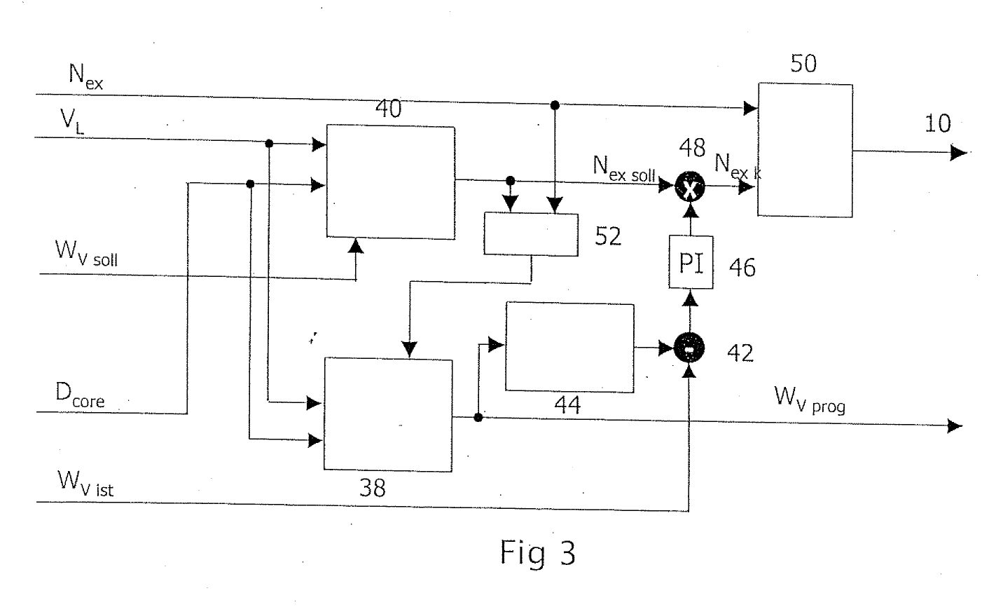

The regulation of the extruder and the adaptation of the extruder model will be explained in more detail by way of the FIGS. 3 to 5.

The virtual measuring head 36 according to FIG. 3 contains an extruder model 38 and an inverse extruder model 40. Involved into the extruder model 38 are the data for the line speed VL, the core diameter Dcore and either a desired value for the rotational speed of the extruder nexsoll or the rotational speed of the extruder nex. Involved into the inverse extruder model 40 are the data for the line speed VL, the desired wall thickness Wvsoll and the core diameter Dcore. The extruder models 38, 40 map the dependence of the volume output per unit time (the output capacity) on the extruder's rotational speed and the line speed. Taking into account the core diameter Dcore, a wall thickness results from this, which the extruder 10 should produce when its production- or characteristic data are taken as a basis. The characteristic curve for the ratio of the volume output with regard to the extruder's rotational speed is a variable which is typical for machine and material. When the output of the machine corresponds to the calculable behaviour, the wall thickness is also calculable, and thus settable. Naturally, this is not the case in practice. Anyway, it is possible to determine the predictable wall thickness of the sheathing, which is done with the aid of the extruder model 38. With the aid of the inverse extruder model 40, that rotational speed nexsoll is determined by which the extruder must be operated in order to generate the desired wall thickness value at prest line speed. In a comparator device 42, the wall thickness of the sheathing measured by the measuring head 32 is compared with the predicted wall thickness value WVprog. The measuring head 32 measures the wall thickness of the sheathing in a more or less large distance from the exit of the extruder. A shift register 44 transmits the predicted wall thickness value Wvprog with a time delay to the comparator device 42, so that the wall thickness comparison takes place at the same location of the cable, namely on the location of the measuring head, when a predicted value at the extruder's exit has arrived on the measuring head 32 with delay. A PI-controller 46 generates a correction value from the difference, which corrects the desired value nexsoll of the inverse extruder model 40 at 48. The corrected desired value nexk is then given up to the adjustment device for the rotational speed of the extruder via a switch 50. With the aid of the switch 50, the corrected rotational speed value can be given to the extruder 10, or at option directly the desired value for the rotational speed nex preset by the line operator. At option, a switch 52 gives up the mentioned rotational speed value nex or the desired value for the rotational speed nexsoll determined by the inverse extruder model 40 to the extruder model 38.

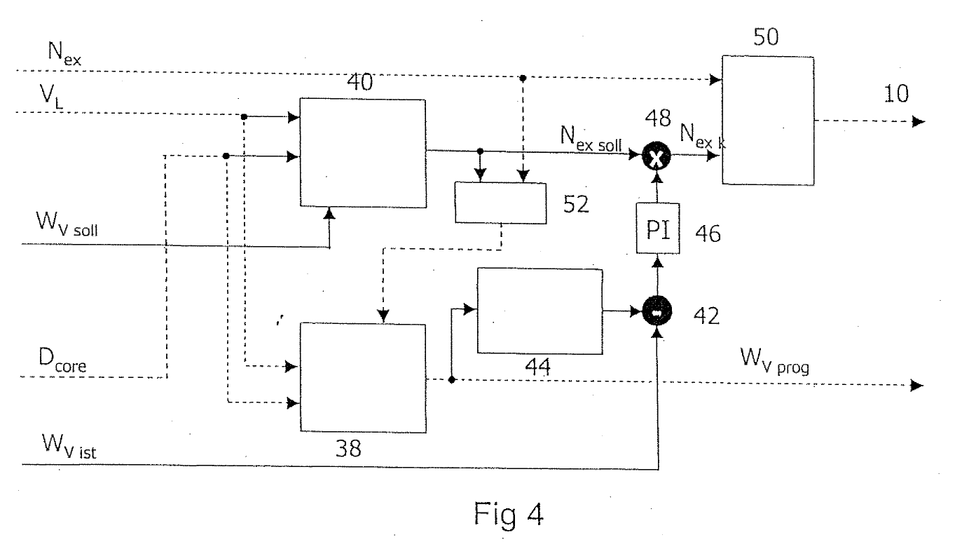

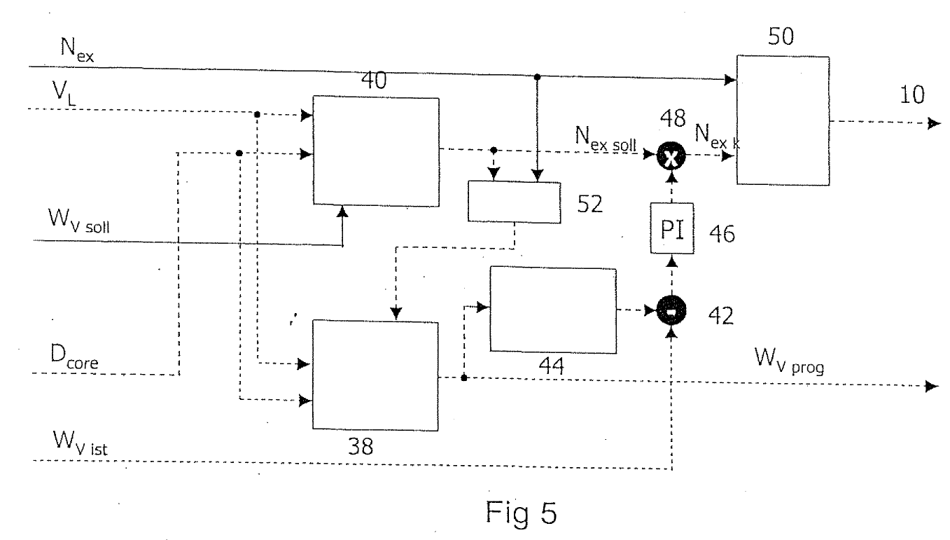

In FIG. 4, the same arrangement as in FIG. 3 is depicted, wherein the manual operation of the production plant is to be indicated by the dashed action lines. A manual operation takes place predominantly during the run-up of the production plant, at slow line speed. The desired value preset by the desired value transmitter 34 (FIG. 2), which is set by the line operator, arrives directly on the extruder 10 via the switch 50. At the same time, the line operator presets the line speed via the desired value transmitter 31 (FIG. 2). The predicted wall thickness value is calculated with the aid of the extruder model 38, based on the mentioned data, and is shown on a not shown display. Thus, the line operator can recognise from on the beginning which value the wall thickness will take on at the indicated data. Due to his/her experience, the line operator will approximately know which rotational speed and which line speed must be set in order to achieve a desired wall thickness value WVsoll. In this, the display shows her/him the predicted value of the wall thickness. By changing the desired value for the extruder nex preset by him/herself, he/she can draw the predicted wall thickness value WVprog near to the wall thickness desired value WVsoll. As soon as the plant is set up, the line operator can change over the plant into automatic operation, and run up the line speed to production speed. The operation in the automatic mode is shown in FIG. 5.

By switching over the switch 50, the rotational speed desired value transmitter 34 becomes noneffective. In FIG. 5, the dashed action lines show the mode of operation. As already mentioned, the inverse extruder model 40 calculates a desired value nexsoll for the extruder from the line speed VL, the core diameter Dcore and the desired wall thickness WVsoll. Via the switched-over switch 52, the same arrives also on the extruder model 38, which determines the predicted wall thickness WVprog from this value and from the line speed and the core diameter. Via the shift register 44, this predicted wall thickness arrives also on the comparator device 42. Thus, the extruder 10 is at first controlled by a desired value for the rotational speed, which is determined with the aid of the virtual measuring head. The same may not exactly correspond to the desired wall thickness value, yet it is very near to the desired value however. Consequently, it has not to be waited until what comes out of the extruder reaches the measuring head 32. A path of more than 100 m is for instance necessary for this. When the measuring head is reached, a regulation can begin by comparing the measured wall thickness value WVist with the predicted wall thickness value WVprog, in fact on the location of the measuring head 32. Via the controller 46, the difference arrives at a correction stage 48 in which the predicted desired value for the rotational speed nexsoll is corrected in order to bring the real value of the wall thickness definitely to the desired value for the wall thickness. However, this correction is relatively small, because already the predicted wall thickness value WVprog has approached the desired value for the wall thickness in a high degree. It is also possible to realise the correction via an adaptation of the output capacity of the extruder on which the extruder model and the inverse extruder model are based.

In analogy to the method described just now, the rotational speed of the extruder screw can of course also be used as the guide value, and the extruder model predicts then the line speed. Deviations between the real wall thickness and the predicted wall thickness regulate the rotational speed of the extruder's screw and/or the haul-off speed, or there is a correction of the extruder model.

When knowing the core diameter, wall thicknesses can be simply converted into diameter values when such display values or regulations are required.

In the arrangement according to FIG. 2a, the drive of the cable 16, the extruder 10 and the cooling path 18 according to FIG. 1 are indicated together in the block. A first desired value transmitter 31 in the form of a potentiometer presets the line speed vL. A second desired value transmitter 34 in the form of a potentiometer presets the rotational speed (screw rotational speed) for the extruder 10. The two desired value transmitters 31, 34 are adapted to be changed by way of a so-called “master potentiometer” 33 such that their ratio remains constant. The rotational speed nex and the desired wall thickness for the sheathing of the cable WVsoll are given up to a “virtual measuring head” 36, which receives also the measurement value for the core diameter Dcore, as well as the value for the line speed VL. As will still be explained in the following, the virtual measuring head 36 contains a model of the extruder 10 and if need be a wall thickness regulation. The latter will also be explained in more detail below. By calculation, the virtual measuring head 36 generates a desired value for the line speed vLsoll as an adjusting value for the line speed via the drive 16. Besides, the virtual measuring head 16 generates a display value for the wall thickness of the sheathing, which is predicted on the basis of the data present in and input into the virtual measuring head. The same is designated by WVprog in FIG. 2a. The line operator can read this value on his/her display table. It will be relatively near to the definitive desired value for the wall thickness WVsoll. However, the measuring head 32 measures the really generated wall thickness and gives it up to the virtual measuring head 36. Thus, the difference between measured and predicted wall thickness (WVsoll−WVist) is used for regulating the line speed via the drive 16, or to adapt the extruder model in the virtual measuring head 36 correspondingly.

As shown in FIG. 2 and FIG. 2a, the presetting for the line speed VL is given up to the extruder 10 via a block 54. This block causes that the dynamic behaviour of the extruder is imposed on the line speed and compensated by doing so. As described above, the desired wall thickness can be maintained when the line speed is correspondingly adapted during a change of the extruder's rotational speed. In this way, an excessive or insufficient wall thickness during the change of the rotational speed is avoided. Changes of the rotational speed take place for instance when the cable production is slowed down in order to exchange a winding drum and to connect the cable to a new winding drum. During this time, the cable is produced with decreased speed, for instance into a storing device. When speeding up again to the production speed thereafter, there is also the danger of a change of the wall thickness, which is compensated in that the line speed is adapted to the change of the volume output capacity.

The realisation example above is related to a cable production. The present invention can be utilised to the same degree in the production of arbitrary extrudates from plastic material, which are extended in an extruder; for instance pipes or tubes.

A diameter measuring device can also be used, instead of an X-ray measuring device 32.

1. A method for the operation of a production plant to produce an extrudate, in which at least one layer of the extrudate is extruded from plastic material in at least one extruder which is variable in the rotational speed of its screw, wherein the speed of the extrudate (line speed) is variable and in which further the diameter and/or or the wall thickness of the layer is measured by a measuring head in a distance from the extruder, characterised through the following steps:
an algorithm is memorised in a computer in an extruder model for calculating diameter values and/or wall thickness values of the layer, taking into account the rotational speed dependent output capacity of the extruder, the inside diameter of the layer and the line speed,
the extruder model is compiled from the volume output (extruder capacity) by measuring the wall thickness and/or the diameter, the extruder's rotational speed, the line speed and the inside diameter and/or the core diameter,
when making the extrudate, the value for diameter and/or wall thickness predictably generated by the extruder is calculated in the extruder model for an inside diameter, a line speed, a rotational speed of the extruder's screw, and data for the output capacity of the extruder that depend on the rotational speed,
the calculated, predictable value for diameter and/or wall thickness is displayed, and
by changing the rotational speed of the extruder's screw and/or the line speed, the calculated and displayed value for diameter and/or wall thickness is brought to the desired value for diameter and/or wall thickness.

2. A method according to claim 1, characterised in that the at least one layer is extruded as a sheathing on a core (conductor) of a cable which is guided through the extruder with line speed.

3. A method according to claim 1, characterised in that the plastic material, if necessary the cross sectional area of the layer, if necessary the mass temperature, if necessary the mass pressure in the extruder, if necessary the power of the extruder drive is involved in the calculation of the volume output capacity of the extruder.

4. A method according to claim 1, characterised in that an (inverse) extruder model is memorised in the computer for the automatically performed method, in which;
the relation of the extruder's rotational speed and the achievable value for the diameter and/or the wall thickness is mapped in accordance with the inside or core diameter, respectively, the line speed and the rotational speed dependent output capacity of the extruder,
a desired value for the rotational speed of the extruder's screw and/or for the line speed is delivered to the respective drives, which is calculated in the (inverse) extruder model for preset values of wall thickness and/or diameter, line speed and inside or core diameter, respectively,
the measuring head measures the real value for diameter and/or wall thickness of the sheathing,
the calculated value for diameter and/or wall thickness is compared with the real value on the location of the measuring head,
with the deviation of the real value from the desired value, the rotational speed of the extruder and/or the line speed is regulated such or the extruder model is customised such that the desired value for diameter and/or wall thickness is achieved.

5. A method according to claim 4, characterised in that the desired values for rotational speed and/or line speed calculated in the (inverse) extruder model for diameter and/or wall thickness are corrected by way of the deviation between desired value and real value of diameter and/or wall thickness.

6. A method according to claim 4, characterised in that the calculated value for diameter and/or wall thickness is input into a delay line memory controlled by the line speed, for the sake of location-adjusted comparison with a real value measured by the measuring head.

7. A method according to claim 6, characterised in that further process relevant data, the extruder's rotational speed and the haul-off speed are continuously fed into a delay line memory controlled by the line speed, for location adjusted comparison with previously calculated values and basic data on which the calculated data are based, for the sake of deriving an error signal for the correction of the extruder model and/or the desired value presettings for the extruder's rotational speed and/or the line speed.

8. A method according to claim 1, characterised in that the change in time of the wall thickness or the diameter is determined when there is a significant change of the rotational speed of the extruder, and a first functional correlation is generated from which a second functional correlation is determined and memorised in the computer, such that the line speed is controlled in accordance with the second functional correlation so that the wall thickness or the diameter, respectively, remains constant.

9. A method according to claim 1, characterised in that core diameter and/or wall thickness and/or the external diameter is measured with an x-ray measuring device.

10. A method according to claim 2, characterised in that a measuring head measures the core diameter, and the value for the core diameter is incorporated into the extruder model or the inverse extruder model, respectively.
